(19) United States
(12) Patent Application Publication
(10) Pub. No.: US 2009/0185334 A1
(43) Pub. Date: Jul. 23, 2009

(54) Distribution Box and A Method for Thermographic Scanning Thereof

(76) Inventor: Ami Shefet, Kfar Yona (IL)

Correspondence Address: HAIM FACTOR;Ofek Group Inc., 16192 Coastal Highway, Lewes, DE, 19958, US

(21) Appl. No.: 12/015,518

(22) Filed: Jan. 17, 2008

(51) Int. Cl. H02B 1/26

(52) U.S. Cl. 361/641

(57) ABSTRACT

In one aspect, the present invention is directed to a distribution box, comprising: a distribution board; a shield protecting the electric components of the board; an aperture located in the shield; and a net covering the aperture, thereby allowing an infrared camera to scan the area wherein the electric components of the distribution are deployed, through the aperture, without removing the shield. In a preferred embodiment of the invention, the net filters less than about 50 percents of the beams reaching to the net. The net may be secured to the shield by an adhesive layer, bolts, and so on. In a preferred embodiment of the present invention, the aperture is a bore, preferably of a diameter of about 7.5 cm, thereby suitable for a common distribution box. Preferably, size of the net cavities is less than the corresponding size of a human finger.

### FIELD OF THE INVENTION

The present invention relates to the field of distribution boards. More particularly, the invention is directed to a distribution box and a method for thermographic scanning thereof.

### BACKGROUND OF THE INVENTION

A distribution board is a device which divides the electrical main feed into various circuits, providing a fuse or circuit breaker for each circuit. Distribution boards are also known as breaker panels, fuse boxes, consumer units, panel boards, load centers, among others.

A distribution board is usually located in a box, referred to herein as “distribution box”.

Distribution boxes usually comprise a shield, for protecting a user from unintended contact with electric wires and other components of a distribution board. The shield is often a plastic board, usually transparent, thereby allowing a user to see the electric components.

Enterprises carry out periodic thermographic tests of their distribution boards in order to ascertain that all the components are well secured, with no hot spots on the board which could flare and result in a major electrical fire. Such tests are carried out by an infrared camera. But, since infrared signals cannot pass through the plastic shield, the shield should be removed from the distribution board before scanning the board with an infrared camera. The activity of removing the shield is time consuming, and also exposes the operator to accidental contact with the electric components.

It is an object of the present invention to allow thermographic scanning of a distribution board without removing the protective shield thereof.

It is another object of the present invention to allow thermographic scanning of a distribution board without exposing the operator thereof to the danger of contact with the electric components.

Other objects and advantages of the invention will become apparent as the description proceeds.

### SUMMARY OF THE INVENTION

The following embodiments and aspects thereof are described and illustrated in conjunction with systems, tools and methods, which are meant to be merely illustrative, not limiting in scope. In various embodiments, one or more of the above-described problems have been reduced or eliminated, while other embodiments are directed to other advantages or improvements.

The term “net” refers herein to a substantially flat sheet having a group of unblocked regions and a group of blocked regions, arranged in substantially a balanced order, such as a grid and the like.

In one aspect, the present invention is directed to a distribution box, comprising:
a distribution board;
a shield protecting the electric components of the board;
an aperture located in the shield; and
a net covering the aperture;
   thereby allowing thermographic scanning of the area in which the electric components of the distribution board are deployed, through the aperture, without removing the shield.

In another aspect, the present invention is directed to a method for thermographic scanning of a distribution board, the method comprising the steps of:
opening an aperture in a shield of the distribution box;
covering the aperture by a net; and
rendering thermographic scan of the distribution board of the distribution box through the aperture;
   wherein the aperture is located in such position that an infrared camera is able to render thermographic scan therethrough without shield removal.

In a preferred embodiment of the invention, the net filters less than about 50 percents of the beams reaching to the net.

The net may be secured to the shield by an adhesive layer, bolts, and so on.

In a preferred embodiment of the present invention, the aperture is a bore, preferably having a diameter of about 7.5 cm, thereby suitable for a common distribution box.

Preferably, the fibers of the net are rigid, thereby being a protective shield.

Preferably the size of the net cavities is less than the corresponding size of a human finger.

According to one embodiment of the invention, the aperture overlaps the entire shield.

In addition to the exemplary aspects and embodiments described above, further aspects and embodiments will become apparent by reference to the figures and by study of the following detailed description.

### BRIEF DESCRIPTION OF THE DRAWINGS

The objects and features of the present invention will become apparent from the following detailed description considered in conjunction with the accompanying drawings, in which:

FIG. 1 schematically illustrates a distribution box, according to the prior art.

FIG. 2 schematically illustrates a distribution box, according to one embodiment of the invention.

FIG. 3 is an exploded view schematically illustrating a distribution box, according to one embodiment of the invention.

FIG. 4 is a sectional view which schematically illustrates a process of rendering thermographic scan of the components of a distribution board by an infrared camera, according to one embodiment of the invention.

It is to be understood, however, that the drawings are designed solely for purposes of illustration and not as a definition of the limits of the invention, for which reference should be made to the appended claims. It should be further understood that the drawings are not necessarily drawn to scale and that, unless otherwise indicated, are merely intended to conceptually illustrate the structures and procedures described herein. Reference numerals may be repeated among the figures in order to indicate corresponding or analogous elements.

### DETAILED DESCRIPTION OF PREFERRED EMBODIMENTS

In the following detailed description, numerous specific details are set forth in order to provide a thorough understanding of the invention. However, it will be understood by those skilled in the art that the present invention may be practiced without these specific details. In some instances, well-known methods, procedures, components and circuits have not been described in detail, for the sake of brevity.

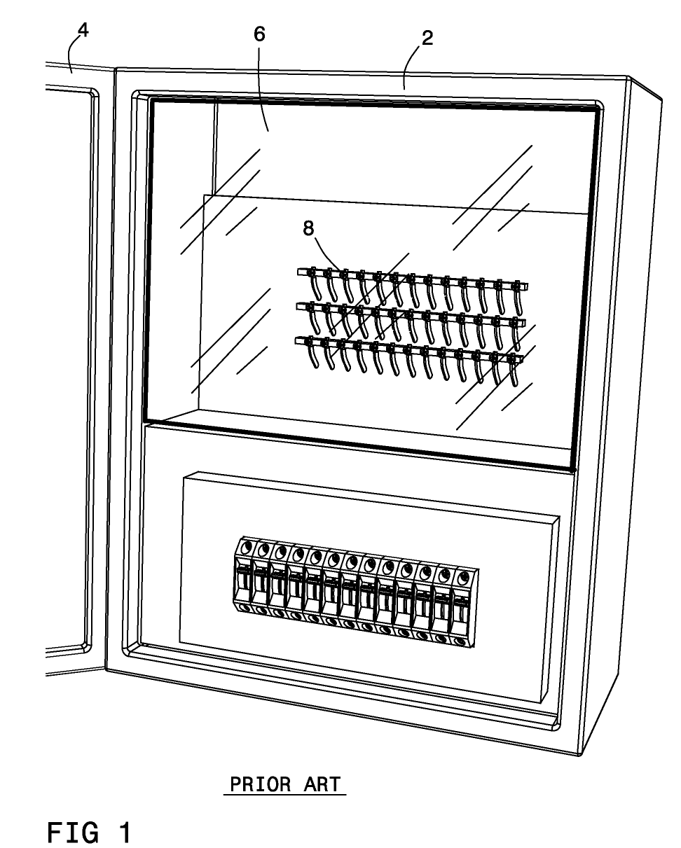

FIG. 1 schematically illustrates a distribution box, according to the prior art.

The distribution box 2 illustrated in this figure comprises a distribution board 6 in which the electric components and contacts 4 are deployed. The electric components 4 are protected by a transparent plastic shield 6.

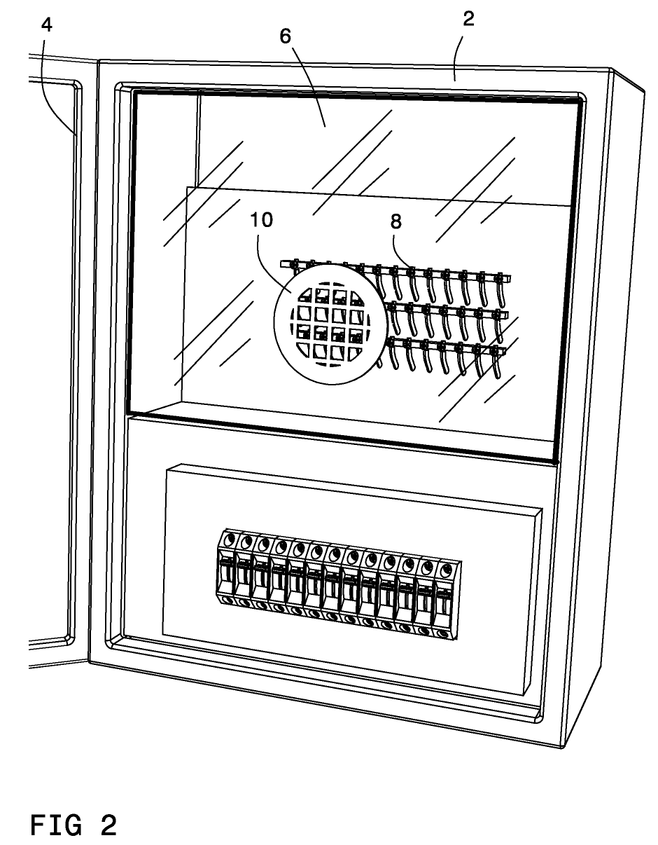

FIG. 2 schematically illustrates a distribution box, according to one embodiment of the invention.

According to this embodiment of the invention, plastic shield 6 comprises an aperture shielded by a net 10.

Net 10 comprises two kinds of regions: unblocked regions (cavities), and blocked regions (fibers). As such, the net features two characteristics: on the one hand, the unblocked regions thereof allow infrared radiation from the distribution board to pass through, and in other words enabling an adequate energy amount for producing a thermal image to pass through. On the other hand, a user cannot pass his fingers through the net, thereby providing a device of improved safety in comparison to the prior art. Of course, dimensions of the cavities must be less than the corresponding dimensions of a finger.

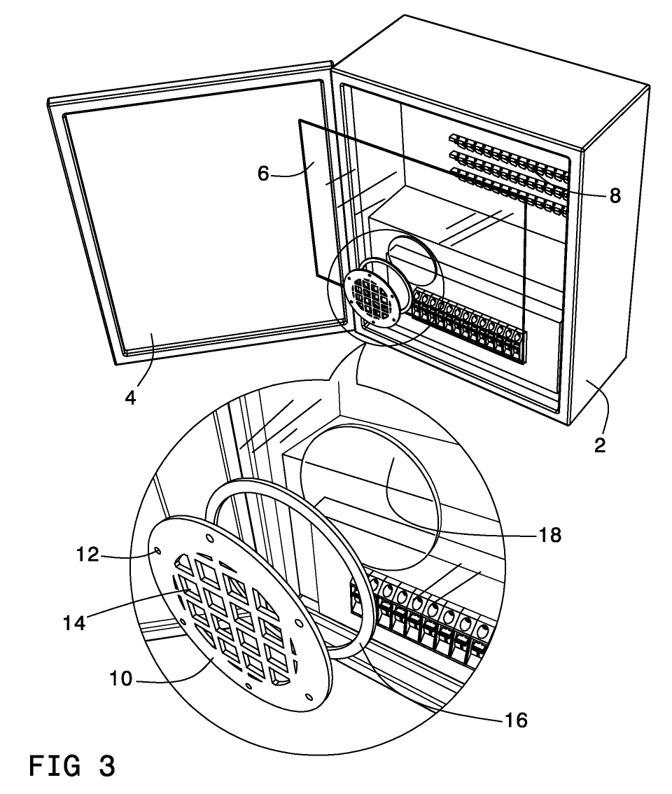

FIG. 3 is an exploded view schematically illustrating a distribution box, according to one embodiment of the invention.

The zoomed view focuses on net 10, and the manner in which it is connected to plastic shield 6.

As illustrated, plastic shield 6 comprises an aperture 18 through which an infrared camera is able to render thermographic scan of the distribution board. Aperture 18 is located at a location where an infrared camera (not illustrated) can scan the entire region of the distribution board in which the electric components are deployed.

An adhesive layer 16 connects net 10 to plastic shield 6. Net 10 can be secured to the plastic shield by bolts (not illustrated) through cavities 12. While an adherent loses its efficiency as the time goes by, mechanical means such as bolts may be effective for a longer period.

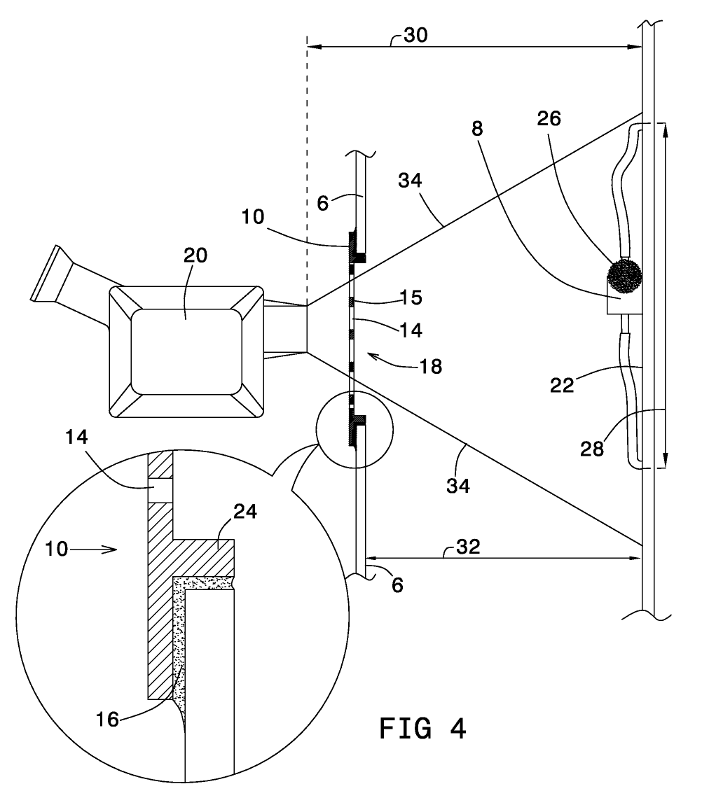

FIG. 4 is a sectional view which schematically illustrates a process of thermographic scanning of the components of a distribution board by an infrared camera, according to one embodiment of the invention.

Numeral 26 denotes a heated spot, indicating a local problem in this region, such as a loosened contact between electrical components.

As known to persons of ordinary skill in the art, since the view area of camera 20 is restricted (the edges of the view area are marked by numeral 34), when scanning area 22 (the length thereof is determined by numeral 28), the part of the distribution board in which components 8 are deployed, the camera has to be placed at least a certain distance 30 from the scanned area 22.

In addition, the size of aperture 18 depends on the distance between shield 6 and the scanned area 22. This distance is marked herein by numeral 32.

Experiments made by the author of the present invention have shown that net 10 must filter no more than 50% of the light beams in order to be effective for thermographic scanning. In other words, the wires of an effective net 10 must block no more than 50% of the total area of the net to be effective for thermographic scanning.

It should be noted that although it is possible to place the net on door 4 of the distribution box 2 (door 4 is seen in FIGS. 1 to 3), in the event the distribution box is placed outdoors, due to aperture 18 the electric components are exposed to rain, snow, humidity, and so on, resulting in a breach of security.

The location of aperture 18 can be determined, for example, by placing camera 20 on a tripod in a location wherein the entire area 22 to be scanned is covered. Then, a user manually marks the location of aperture 18. This can be done, for example, with the assistance of another user: the user that looks through the camera can direct the other user to mark the location of aperture 18 in a proper position.

Afterwards, the plastic shield must be removed from the distribution board for safety's sake. When the shield is removed, aperture 18 may be drilled in a safe manner. It should be noted that although drilling a bore is a relatively simple and fast operation, the aperture may be performed by other means, such as a vertical saw.

Then the net is mounted on the shield, and secured via an adherent layer 16 (such as of the Bison enterprise) and bolts (not illustrated). Plastic shield 6 is then remounted on the distribution box.

Employing a “common” infrared camera on a “common” distribution box, a suitable net diameter is about 7.5 cm.

The covered area 22 can be approximately calculated by the following formula:

F=4×D

wherein D is the distance between the scanned area 22 and shield 6. “D” is marked herein by numeral 32. For example, if D is 20 cm, then covered area F (marked herein by numeral 22) will be approximately 80 squared cm.

It should be noted that although the examples herein are referred to an infrared camera, the infrared camera is merely an example, and any thermographic scanning technology will do. Thus, the terms “camera” and “infrared camera” refer to any thermographic scanner.

In the figures and description herein, the following numerals have been mentioned:
numeral 2 denotes a distribution box;
numeral 4 denotes a door of the distribution box;
numeral 6 denotes a security shield of the distribution box;
numeral 8 denotes electric components of the distribution box;
numeral 10 denotes a net;
numeral 12 denotes a cavity in net 10 through which a bolt can secure the net to a board;
numeral 14 denotes the cavities (uncovered regions) of the net;
numeral 15 denotes a net fiber;
numeral 16 denotes an adhesive layer;
numeral 18 denotes an aperture in the protective shield;
numeral 20 denotes an infrared camera;
numeral 22 denotes the area scanned by camera 20;
numeral 24 denotes an elevated rim, for centering net 10 in aperture 18;
numeral 26 denotes a heated spot;
numeral 28 denotes the size of the scanned area;
numeral 30 denotes the distance between camera 20 and the scanned components area;
numeral 32 denotes the distance between shield 6 and the scanned area; and
numeral 34 denotes the edges of the view area of camera 20.

While certain features of the invention have been illustrated and described herein, the invention can be embodied in other forms, ways, modifications, substitutions, changes, equivalents, and so forth. The foregoing description of the embodiments of the invention has been presented for the purposes of illustration and description. It is not intended to be exhaustive or to limit the invention to the precise form disclosed. Many modifications and variations are possible in light of this disclosure. It is intended that the scope of the invention be limited not by this detailed description, but rather by the claims appended hereto.

What is claimed is:

1. A distribution box, comprising:
a distribution board;
a shield protecting the electric components of said board;
an aperture located in said shield; and
a net covering said aperture;
thereby allowing an infrared camera to scan the area in which the electric components of said distribution board are deployed, through said aperture, without removing said shield.

2. A distribution box according to claim 1, wherein said net filters less than about 50 percents of the beams reaching to said net.

3. A distribution box according to claim 1, wherein said net is secured to said shield by an adhesive layer.

4. A distribution box according to claim 1, wherein said net is secured to said shield by a plurality of bolts.

5. A distribution box according to claim 1, wherein said aperture is a bore.

6. A distribution box according to claim 5, wherein the diameter of said bore is about 7.5 cm.

7. A distribution box according to claim 1, wherein the size of the cavities of said net is less than the corresponding size of a human finger.

8. A distribution box according to claim 1, wherein the fibers of said net are of rigid material.

9. A distribution box according to claim 1, wherein said aperture overlaps the entire shield.

10. A method for thermographic scanning of a distribution board, the method comprising the steps of:
opening an aperture in a shield of said distribution box;
covering said aperture by a net; and
scanning the distribution board of said distribution box through said aperture;
wherein said aperture is located in such position to enable an infrared camera to render a thermographic scan therethrough without removing said shield.

11. A method according to claim 10, wherein said net filters less than about 50 percents of the beams reaching said net.

12. A method according to claim 10, wherein said aperture is a bore.

13. A method according to claim 12, wherein the diameter of said bore is about 7.5 cm.
